(19) United States
(12) Patent Application Publication
(10) Pub. No.: US 2012/0207041 A1
(43) Pub. Date: Aug. 16, 2012

(54) SYSTEM AND METHOD FOR TAGGING CLIENT/NETWORK INFORMATION IN HEADERS OF DATA PACKETS

(75) Inventors: Philippe Piernot, Palo Alto, CA (US); Yixiang Chen, Palo Alto, CA (US)

(73) Assignee: OPENWAVE SYSTEMS INC., Redwood City, CA (US)

(21) Appl. No.: 13/244,565

(22) Filed: Sep. 25, 2011

Related U.S. Application Data
(60) Provisional application No. 61/442,291, filed on Feb. 13, 2011.

(51) Int. Cl. H04W 24/00; H04L 12/26

(52) U.S. Cl. 370/252

(57) ABSTRACT

A system and method for tagging client/network information in mobile data packet traffic intercepts a data packet from a wireless mobile device, which includes client-related information embedded in a header of the data packet, at a mobile access network. The client-related information is then extracted from the data packet for processing.

### CROSS-REFERENCE TO RELATED APPLICATION

This application is entitled to the benefit of provisional U.S. Patent Application Ser. No. 61/442,291, filed Feb. 13, 2011, which is incorporated herein by reference.

### BACKGROUND

Wireless mobile devices, such as smart phones and tablet computers, typically use wireless carrier networks to transmit and receive data in the form of data packets. The wireless carrier networks usually process data to and from the wireless mobile devices without any knowledge about the wireless mobile devices or information residing in the wireless mobile devices. Conversely, the wireless mobile devices usually process data to and from the wireless carrier networks without any knowledge about the wireless carrier networks or information residing in the wireless carrier networks.

However, there is a need for the wireless carrier networks to have knowledge about the wireless mobile devices or information residing in the wireless mobile devices for various purposes, such as billing, bandwidth analytics, quality of service or security purposes. Similarly, there is a need for the wireless mobile devices to have knowledge about the wireless carrier networks information residing in the wireless carrier networks for various purposes, such as modifying data usage based on remaining level of monthly data usage plan or based on data traffic conditions of the wireless carrier networks.

### SUMMARY

A system and method for tagging client/network information in mobile data packet traffic intercepts a data packet from a wireless mobile device, which includes client-related information embedded in a header of the data packet, at a mobile access network. The client-related information is then extracted from the data packet for processing. The client-related information can be used for various purposes, such as billing, bandwidth analytics, quality of service or security purposes.

A system for tagging client/network information in mobile data packet traffic in accordance with an embodiment of the invention comprises a packet interception unit and at least on processing unit. The packet interception unit is configured to intercept a data packet from a wireless mobile device. The data packet includes client-related information embedded in a header of the data packet. The client-related information includes information about a wireless mobile device that sent the data packet or information residing in the wireless mobile device. The at least one processing unit is configured to receive the data packet from the packet interception unit. The at least one processing unit is further configured to extract the client-related information embedded in the header of the data packet for processing.

A method for tagging client/network information in mobile data packet traffic in accordance with an embodiment of the invention comprises intercepting a data packet from a wireless mobile device at a network device within a mobile access network, the data packet including client-related information embedded in a header of the data packet, the client-related information including information about the wireless mobile device that sent the data packet or information residing in the wireless mobile device, and extracting the client-related information embedded in the header of the data packet within the mobile access network for processing. The client-related information may include an identification of an application running on the wireless mobile device from which the data packet originated.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a mobile communication network that includes a data traffic tagging system in accordance with an embodiment of the invention.

FIG. 2 is a block diagram of a wireless mobile device of the data traffic tagging system in accordance with an embodiment of the invention.

FIG. 3 is a block diagram of a network tagging subsystem of the data traffic tagging system in accordance with an embodiment of the invention.

FIG. 4 is a data flow sequence diagram of the data traffic tagging system in accordance with an embodiment of the invention.

FIG. 5 is a flow diagram of a method for tagging client/network information in headers of mobile data packet traffic in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

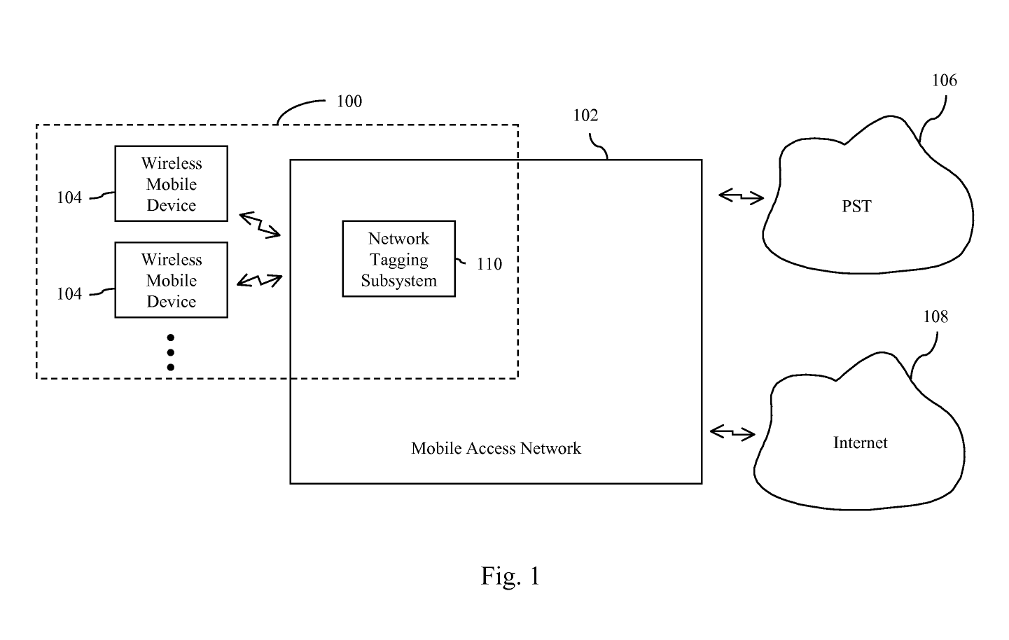

Turning now to FIG. 1, a mobile communication network that includes a data traffic tagging system 100 in accordance with an embodiment of the invention is shown. As shown in FIG. 1, the mobile communication network includes a mobile access network 102, which allows wireless mobile devices 104 to access the public switched telephone network (PSTN) 106, the Internet 108 and/or other wireless mobile devices. The mobile access network may also be connected to other networks (not shown), such as private telephone networks and/or data networks. In the illustrated embodiment, the data traffic tagging system 100 includes the wireless mobile devices and a network tagging subsystem 100, which is at least partially located within the mobile access network. As described in more detail below, the data traffic tagging system allows the wireless mobile devices to embed client-related information in outgoing data traffic (i.e., data traffic from the wireless mobile devices), which is then extracted by the network tagging subsystem. The client-related information can be any information about the wireless mobile devices and/or information residing in the wireless mobile devices. The extracted client-related information from the outgoing data traffic can be used for various purposes, such as billing, bandwidth analytics, quality of service or security purposes. In some embodiments, the data traffic tagging system allows the network tagging subsystem to embed network-related information in incoming data traffic (i.e., data traffic to the wireless mobile devices), which is then extracted by the wireless mobile devices. The network-related information can be any information about the mobile access network and/or information residing in or accessible by the mobile access network. The extracted network-related information from the incoming data traffic can be used for various purposes, such as modifying data usage based on remaining level of monthly data usage plan or based on data traffic conditions of the wireless carrier networks.

The mobile access network 102 can be any type of a mobile access network, such as a Universal Mobile Telecommunication System (UMTS) network or a CDMA2000 network, which provides communication services for the wireless mobile devices 104. The mobile access network includes network devices that are commonly found in conventional mobile access networks, such as gateways, routers and proxies, which are not illustrated and described herein so as to not obscure the inventive features of the invention.

The wireless mobile devices 104 are devices that are subscribed to the communication services of the mobile access network 102. The wireless mobile devices can be any type of wireless mobile devices, such as cell phones, smartphones, personal digital assistants (PDAs), netbooks, laptop computers and tablet computers, than can transmit and receive data in the form of data packets. The wireless mobile devices are described herein as being Internet-enabled devices. Thus, the wireless mobile devices can access the Internet 108 via the mobile access network 102. However, some of the mobile communication devices may not be Internet-enabled devices, which means that these devices would not be accessing the Internet via the mobile access network.

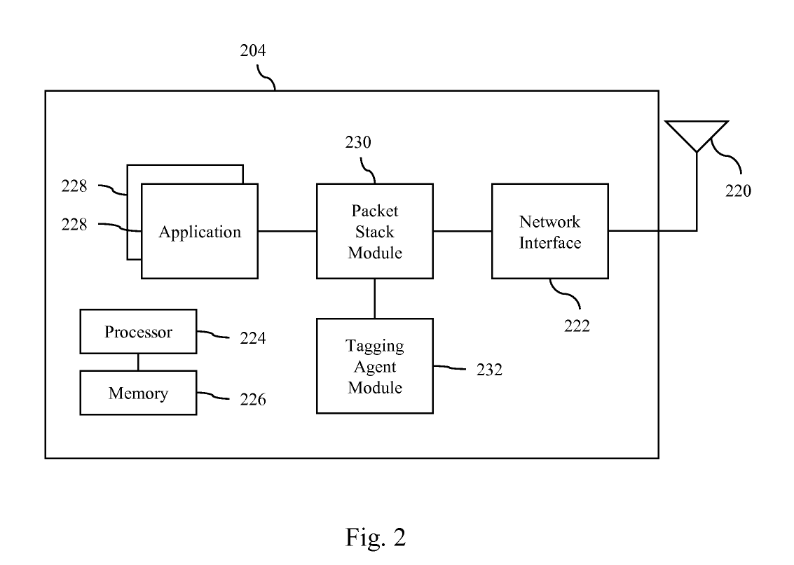

Turning now to FIG. 2, a wireless mobile device 204 in accordance with an embodiment of the invention, which is an example of the wireless mobile devices 104, is shown. As shown in FIG. 2, the wireless mobile device includes at least one antenna 220, a network interface 222, a processor 224, memory 226, one or more applications 228, a packet stack module 230 and a tagging agent module 232. The network interface is configured to transmit outgoing data to the mobile access network 102 using the antenna and to receive incoming data from the mobile access network using the antenna. Although the wireless mobile device is shown with a single antenna, the wireless mobile device may include any number of antennas.

The processor 224 of the wireless mobile device 204 may be a general-purpose digital processor such as a microprocessor or microcontroller. In other embodiments, the processor may be a special-purpose processor such as a digital signal processor. In other embodiments, the processor may be another type of controller or a field programmable gate array (FPGA). The memory 226 of the wireless mobile device can be any type of computer memory, such as read only memory (ROM), flash memory, random access memory (RAM) or a hard disk drive. Although the wireless mobile device is shown and described as having one processor and one memory, the wireless mobile device may include multiple processors and/or multiple memories in other embodiments.

The applications 228 of the wireless mobile device 204 can be any software application executed by the processor 224. In some embodiments, the applications may be configured to transmit and receive data from an external source, such as a server or another wireless mobile device connected to the Internet 108. For example, the applications may include an email application that transmits and receives emails and other data via an email server connected to the Internet or a proprietary application that uses external data from a server connected to the Internet.

The packet stack module 230 of the wireless mobile device 204 is configured to frame outgoing data into data packets for transmission and to de-frame data packets of incoming data to extract payload data from the data packets for processing. In an embodiment, the packet stack module is implemented in software executed by the processor 224. However, in other embodiments, the packet stack module may be implemented in any combination of software, firmware and hardware.

The tagging agent module 230 of the wireless mobile device 204 is configured to embed client-related information in data packets of outgoing data produced by the packet stack module 230. The data packets with the embedded client-related information are then routed back to the packet stack module to be transmitted to the mobile access network 102 via the network interface 222. The embedded client-related information can then be extracted by the network tagging sub-system 110 at the mobile access network and used for various purposes depending on the extracted client-related information.

In some embodiments, the tagging agent module 232 may be configured to embed the client-related information in one of the headers of the data packets. In an embodiment, the tagging agent module may be configured to embed the client-related information at the Internet Protocol (IP) layer in the IP headers of the data packets. As an example, the tagging agent module may embed the client-related information in the “Options” field in the IP headers of the data packets. The “Options” field of an IP header of a data packet may vary in length or size, i.e., the amount of data that can be embedded in the “Options” field. In another embodiment, the tagging agent module may be configured to embed the client-related information at the Transmission Control Protocol (TCP) layer in the TCP headers of the data packets. As an example, the tagging agent module may embed the client-related information in the “Options” field in the TCP headers of the data packets. The “Options” field of a TCP header of a data packet may vary in length or size, i.e., the amount of data that can be embedded in the “Options” field. In other embodiments, the tagging agent module may be able to embed the client-related information at any level on the network stack, such as at application layer (“layer 7”) for Hypertext Transfer Protocol (HTTP), as long as the header used for that layer is well-defined, for example, by a standard, and the header includes a customizable field of sufficient length or size for the client-related information. In some embodiments, the tagging agent module may be configured to embed the client-related information in different headers of the data packets that correspond to different layers, such as the IP layer and the TCP layer.

The client-related information can be any information about wireless mobile device that is not available to the mobile access network. The client-related information may include an identification of the application running on the wireless mobile device that generated the data packet in which the client-related information is embedded. In some embodiments, the application that generated the data packet is unaware of the client-related information embedded in the data packet. The client-related information may also or alternatively include system status information of the wireless mobile device, such as current battery level, processor load and memory level (i.e., the amount of data space available in one or more memories of the wireless mobile device). The client-related information may also or alternatively include capability identifications of the wireless mobile device, such as whether the wireless mobile device can process high definition (HD) video files, whether the wireless mobile device includes a camera or other hardware components, and whether the wireless mobile device includes cell phone capabilities. The client-related information may also or alternatively include make and model of the wireless mobile device. The client-related information may also or alternatively include identifications of applications or other software installed in the wireless mobile device. The client-related information may also or alternatively include sensor data generated at the wireless mobile devices, such as global positioning system (GPS) coordinates from a GPS in the wireless mobile device and other sensor readings from one or more sensors in the wireless mobile device, for example, ambient noise level, compass direction, accelerator/gyroscope values, external temperature and signal strength of the wireless mobile device. The client-related information may also or alternatively include other information residing in the wireless mobile device, e.g., stored in the memory, such as device identification (ID), user ID, user's age group, login/authentication credentials, phone number of the calling party, phone number of called party and user preferences.

In an embodiment, the data packets of the outgoing data may be selectively tagged with the client-related information according to predefined rules. For example, voice-over-IP (VOIP) data packets may be tagged with users' geo-location for E911 purposes, while web browsing data packets may be tagged with battery level information, and all other forms of data packets may be left untagged.

In some embodiments, the tagging agent module 232 of the wireless mobile device 204 is configured to receive data packets of incoming data from the packet stack module 230 and to extract network-related information in the data packets of the incoming data. The network-related information embedded in the data packets of the incoming data is described in more detail below. The extracted network-related information can then be transmitted from the tagging agent module to an appropriate destination within the wireless mobile device, such as an application running on the wireless mobile device, for processing. After the network-related information is extracted from the data packets of the incoming data, the data packets are routed back to the packet stack module so that the data packets can be de-framed and transmitted to the appropriate application(s) running on the wireless mobile device. In an embodiment, the tagging agent module is configured to remove the network-related information in the data packets before the data packets are routed back to the packet stack module so that the data-receiving application(s) is/are unaware of the network-related information that was embedded in the data packets.

In an embodiment, the tagging agent module 232 of the wireless mobile device 204 is implemented in software executed by the processor 224. However, in other embodiments, the tagging agent module may be implemented in any combination of software, firmware and hardware. In some embodiments, the wireless mobile device may include more than one tagging agent module if the wireless mobile device includes more than one port to process outgoing and/or incoming data.

Although not illustrated in FIG. 2, the wireless mobile device 204 may include additional software, firmware and/or hardware components found in conventional wireless mobile devices. For example, the wireless mobile device may include a display, such as an LCD display or a touch screen display, an integrated speaker, an integrated camera, a GPS and cell phone components. These additional software, firmware and/or hardware are not illustrated or described herein so as to not obscure the inventive features of the wireless mobile device.

Turning back to FIG. 1, the network tagging subsystem 110 is illustrated as being located within the mobile access network 102. However, in other embodiments, part of the network tagging subsystem may be located outside of the mobile access network. The network tagging subsystem is configured to intercept the tagged data packets of the outgoing data from the wireless mobile devices 104 to extract the client-related information embedded in the tagged data packets, which may be embedded in one or more headers of the data packets, as described above. The extracted client-related information can then be used for various purposes by the mobile access network or one or more third party entities. In some embodiments, the network tagging subsystem is configured to intercept data packets of incoming data to the wireless mobile devices and to embed network-related information in the data packets to be extracted by the tagging agent modules of the wireless mobile devices.

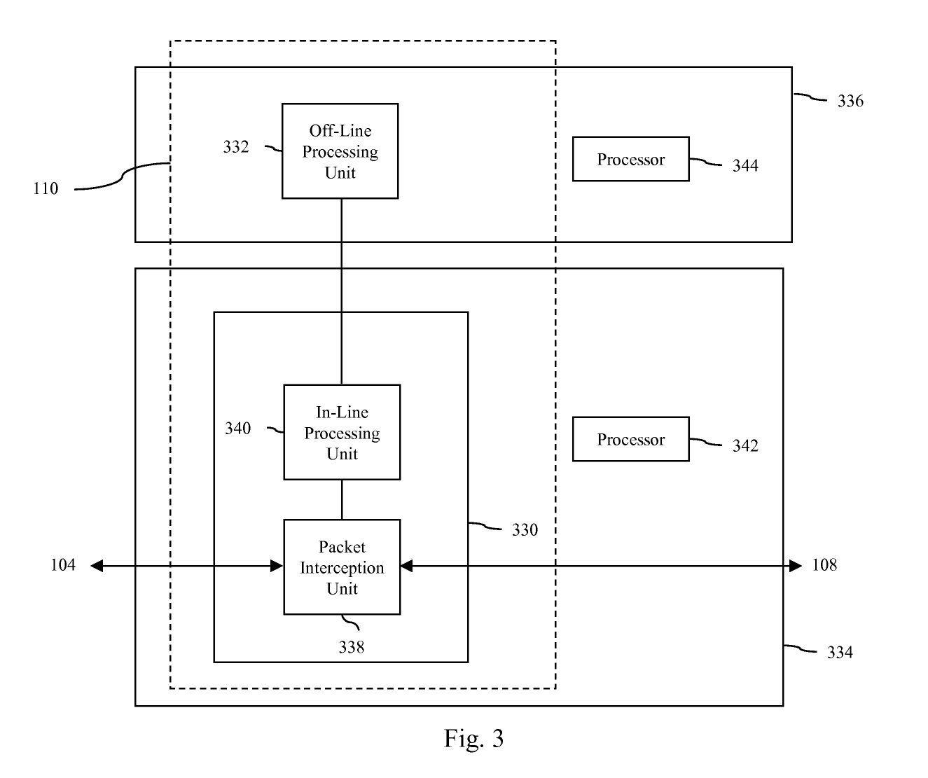

Turning now to FIG. 3, components of the network tagging subsystem 110 in accordance with an embodiment of the invention are shown. As shown in FIG. 3, the network tagging subsystem includes a network tagging module 330 and an off-line tag processing unit 332. Although the network tagging subsystem is shown with a single network tagging module, the network tagging subsystem may include multiple network tagging modules. In the illustrated embodiment, the network tagging module is located within a conventional network gateway 334, which is situated in the mobile access network 102. However, in other embodiments, the network tagging module may be located in another conventional network device in the mobile access network, such as a router. In another embodiment, the network tagging module may be configured as a stand-alone device. In the illustrated embodiment, the off-line tag processing unit is located within a server 336, which is separate from and external to the device that includes network tagging module. However, in other embodiments, the off-line tag processing unit may be located in another conventional network device in the mobile access network. In another embodiment, the off-line tag processing unit may be configured as a stand-alone device.

The network tagging module 330 of the network tagging subsystem 110 includes a packet interception unit 338 and an in-line tag processing unit 340. The packet interception unit is configured is configured to intercept the tagged data packets of the outgoing data from the wireless mobile devices 104 and to forward the intercepted data packets to the in-line tag processing unit for tag extraction. In some embodiments, the packet interception unit is also configured to intercept data packets of incoming data to the wireless mobile devices and to forward the intercepted data packets to the in-line tag processing unit for tag insertion. In an embodiment, the packet interception unit may be implemented in software executed by a processor 342, which may be part of the network tagging subsystem or part of the network device that includes the network tagging subsystem, for example, the network gateway 334. However, in other embodiments, the packet interception unit may be implemented in any combination of software, firmware and hardware.

The in-line tag processing unit 340 of the network tagging module 330 is configured to extract the client-related information from the tagged data packets of the outgoing data that have been intercepted and forward to the in-line tag processing unit. In particular, the in-line tag processing unit is configured to extract the client-related information from one or more headers of the tagged data packets from the wireless mobile devices 104.

In some embodiments, the in-line tag processing unit 340 may be configured to extract additional information from the tagged data packets beside the embedded client-related information, such as 5-tuple identification (i.e., source address, destination address, source port, destination port and protocol). The extracted client-related information and/or additional information, along with pre-configured or dynamically configured rules, to selectively process the data packets in transit. As an example, the in-line tag processing unit may be configured to perform deep packet inspect (DPI) on selective data packets that satisfy the pre-configured or dynamically configured rules using the extracted information. Alternatively, copies of the data packets with or without the embedded client-related information may be transmitted to the off-line tag processing unit 332 for off-line processing without holding the data packets in transit. As another example, the in-line tag processing unit may be configured to change the destinations of selective data packets to different destinations, depending on the pre-configured or dynamically configured rules using the extracted information from the data packets.

The extracted client-related information can be used for various purposes, such as billing, bandwidth analytics, quality of service or security purposes. The following examples are some of the uses of the extracted client-information. In a first example, a mobile access network provider may provide free broadband wireless services to users located at defined locations at defined times as part of a marketing promotion. If the extracted client-related information includes device geolocation information, the wireless mobile devices from the defined locations and times are not charged for data usage. In a second example, a mobile access network provider may provide E911 service for VOIP calls by tagging VOIP packets with the users' location as client-related information and routing the VOIP packets through an E911 friendly datapath. In a third example, a mobile access network provider may block all traffic from particular applications by tagging application ID as client-related information and blocking packets whose application ID is blacklisted. In a fourth example, a mobile access network provider may offer free data when using a particular VOIP application by tagging application ID as client-related information and routing the packets from the particular VOIP application to a free billing datapath. In a fifth example, as an alternative to using multiple access point names (APNs), a mobile access network provider could route traffic based on device make and model by tagging this information as client-related information (e.g., data from latest smartphones could be routed to a datapath with higher quality of service). In a sixth example, a mobile access network provider may want to create detailed maps of signal strength over time, location and phone make/model by tagging this information as client-related information and processing this information extracted from data traffic. In a seventh example, a mobile access network may block traffic to websites in appropriate for certain age group by tagging user ID, specific to user not the device, or user's age group as client-related information and blocking the data packets from users of this age group. In an eight example, certain data packets can be ignored for deep packet inspection (DPI) depending on the type of data format/protocol (e.g., HTTPS POST request, VPN tunnel, DRMed media etc.) for data packets with noting interesting to be extracted by DPI by tagging this information as client-related information and not performing DPI for these tagged data packets.

In some embodiments, the in-line tag processing unit 340 may be configured to remove the client-related information from the tagged data packets during the extraction and to forward the resulting data packets to their destinations, which may be the original destinations or new destinations. Thus, the devices receiving the data packets would be unaware of the client-related information that has been extracted by the in-line tag processing unit.

In some embodiments, the in-line tag processing unit 340 is also configured to receive the intercepted data packets of the incoming data to the wireless mobile devices 104 and to embed the network-related information in one of the headers of the data packets. In an embodiment, the in-line tag processing unit may be configured to embed the network-related information at the IP layer in the IP headers of the data packets. As an example, the in-line tag processing unit may embed the network-related information in the “Options” field in the IP headers of the data packets. In another embodiment, the in-line tag processing unit may be configured to embed the client-related information at the TCP layer in the TCP headers of the data packets. As an example, the in-line tag processing unit may embed the client-related information in the “Options” field in the TCP headers of the data packets. In other embodiments, the in-line tag processing unit may be able to embed the network-related information at another layer as long as the header used for that layer is well-defined, for example, by a standard, and the header includes a customizable field of sufficient length or size for the client-related information. In some embodiments, the in-line tag processing unit may be configured to embed the network-related information in different headers of the data packets that correspond to different layers, such as the IP layer and the TCP layer.

The network-related information can be any information about the mobile access network 102 that is not available to the wireless mobile devices 104. The network-related information may include the current data traffic conditions through the mobile access network, e.g., whether the mobile access network is currently congested or not. As an example, with the knowledge of network congestion from the current data traffic conditions, the wireless mobile devices may stop aggressively pre-fetching content or reduce other operations that require receiving significant amount of data being received from the mobile access network. The network-related information may also or alternatively include information residing in the mobile access network or information accessible by the mobile access network, such as the current remaining level of monthly data usage plan for a specific wireless mobile device. As an example, with the knowledge of certain remaining level of monthly data usage plan, the wireless mobile devices may notify users of that fact or reduce or stop operations that require receiving significant amount of data being received from the mobile access network. In an embodiment, the network-related information could be used to send notification flags that are recognizable by the wireless mobile devices to provide notification services. In another embodiment, the network-related information could be used to ask the wireless mobile devices what kind of network traffic is needed.

In an embodiment, the in-line tag processing unit 340 may be implemented in software executed by the processor 342, which may be part of the network tagging subsystem 110 or part of the network device, e.g., the network gateway 334. In another embodiment, the in-line tag processing unit may be implemented as one or more processors. However, in other embodiments, the in-line tag processing unit may be implemented in any combination of software, firmware and hardware.

The off-line tag processing unit 332 of the network tagging system 110 is an optional component of the network tagging system. The off-line tag processing unit is configured to receive copies of the data packets of the outgoing data sent from the in-line tag processing unit 340 with or without the client-related information and to process the data packets off-line. Thus, the data packets can be processed without holding the packets in transit. If the client-related information has not been extracted from the data packets, the off-line tag processing unit may be configured to extract the client-related information from the received data packets. The off-line tag processing unit may be configured to aggregate the client-related information from the data packets and process the client-related information to be used by the mobile access network 102 or a third party entity.

In some embodiments, the off-line tag processing unit 332 is also configured to receive copies of the data packets of the incoming data sent from the in-line tag processing unit 340 with or without the network-related information and to process the data packets off-line. Thus, the data packets of the incoming data can be processed without holding the packets in transit. The off-line tag processing unit may be configured to aggregate the network-related information from the data packets and process the client-related information to be used by the mobile access network 102 or a third party entity.

In an embodiment, the off-line tag processing unit 332 may be implemented in software executed by a processor 344, which may be part of the server 336 or dedicated to the off-line tag processing unit. In another embodiment, the off-line tag processing unit may be implemented as one or more processors. However, in other embodiments, the off-line tag processing unit may be implemented in any combination of software, firmware and hardware.

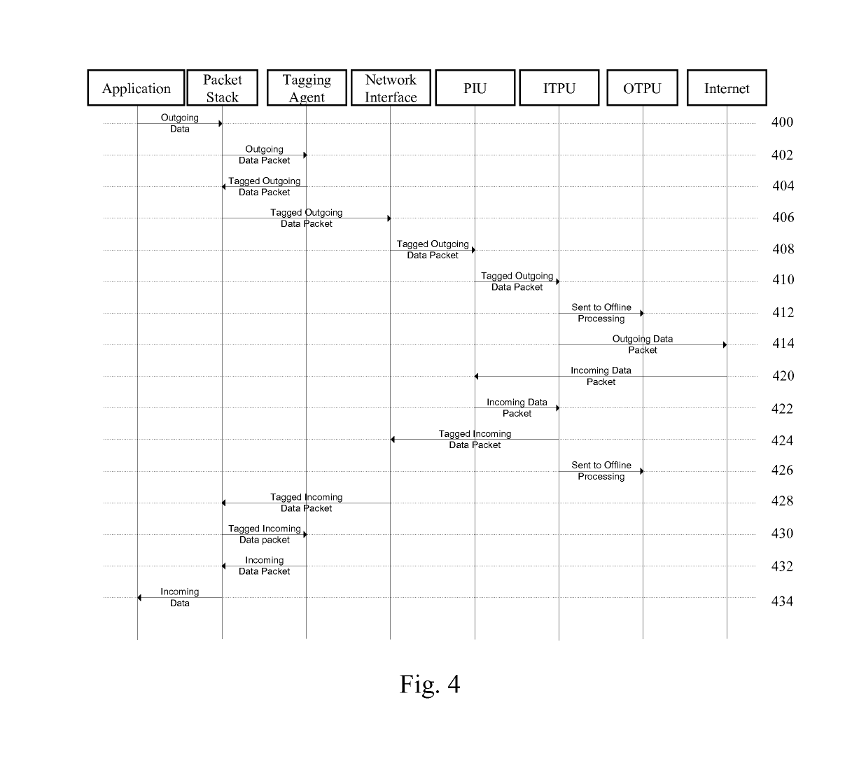

Turning now to FIG. 4, a data flow sequence diagram of the data traffic tagging system in accordance with an embodiment of the invention. Steps 400-414 describe a data flow sequence for outgoing data from a particular application, i.e., the application 228, running on the wireless mobile device 204 to the Internet 108. Steps 420-434 describe a data flow sequence for incoming data from the internet to the application running on the wireless mobile device.

The data flow sequence for data packets of outgoing data traffic begins at step 400, where the application 228 running on the wireless mobile device 204 generates data to be transmitted and sends the data to the packet stack module 230. At step 402, the packet stack module of the wireless mobile device frames the data from the application and sends the resultant data packets to the tagging agent module 232. The tagging agent module then embeds or inserts client-related information into the data packets, e.g., in the IP Options field of the data packets or the TCP Options field of the data packets. At step 404, the tagging agent module sends the tagged data packets back to the packet stack module for network delivery. At step 406, the packet stack module sends the tagged data packets to the network interface 222. At step 408, the network interface then sends off the tagged data packets to the mobile access network 102. At step 410, the packet interception unit 338 of the network tagging module 330 located within the mobile access network 102 intercepts the tagged data packets and forwards the data packets to the in-line tag processing unit 340. The in-line tag processing unit then extracts the client-related information embedded in the data packets. In an embodiment, the in-line tag processing unit also extracts the IP 5-tuple identification. The in-line tag processing unit uses the extracted client-related information and other extracted information, if any, with preconfigured or dynamically configured rules to process the data packets in transit. At optional step 412, the in-line tag processing unit sends copies of the data packets to the off-line tag processing unit 332 for off-line processing without holding the data packets in transit. At step 414, the in-line tag processing unit forwards the data packets to the Internet 108 to be routed to their destinations.

The data flow sequence for data packets of incoming data traffic begins at step 420, where the packet interception unit 338 of the network tagging module 330 intercepts the data packets of the incoming data traffic. At step 422, the packet interception unit forwards the data packets to the in-line processing unit 340 for processing. The in-line processing unit embeds or inserts network-related information into the data packets, e.g., in the IP Options field of the data packets or the TCP Options field of the data packets. In an embodiment, the in-line processing unit uses IP 5-tuple identification and preconfigured or dynamically configured rules to insert the network-related information into the data packets. At step 424, the in-line processing unit sends the tagged data packets to the wireless mobile device 204. At optional step 426, the in-line processing unit sends copies of the tagged data packets to the off-line tag processing unit 332 for off-line processing. At 428, the network interface 222 of the wireless mobile device 204 receives the tagged data packets from the mobile access network 102 and forwards the tagged data packets to the packet stack module 230. At block 430, the packet stack module sends the tagged data packets to the tagging agent module 232 for processing. The tagging agent module then extracts the network-related information from the tagged data packets and processes the data packets according to pre-configured or dynamically configured rules. In an embodiment, the tagging agent module removes the network-related information from the tagged data packets so that the receiving application 228 is unaware of the fact that the network-related information was embedded in the received data packets. At step 432, the tagging agent module sends the data packets back to the packet stack module after the tag extraction. At step 434, the packet stack module de-frames the data packets and sends the data contained in the data packets to the application for processing.

Since the client-related or network-related information can be embedded in each data packet of data traffic, the client-related or network-related information can be packet specific. Thus, packet specific information can be transmitted between the wireless mobile devices to the mobile access network. In addition, since the client-related or network-related information is embedded in the data packets of data traffic using a primary band channel, rather than using a separate out-of-band or back channel, information between the wireless mobile devices 104 to the mobile access network 102 can be exchanged in real-time without significant increase in cost when compared to other solutions may involve using out-of-band or back channel.

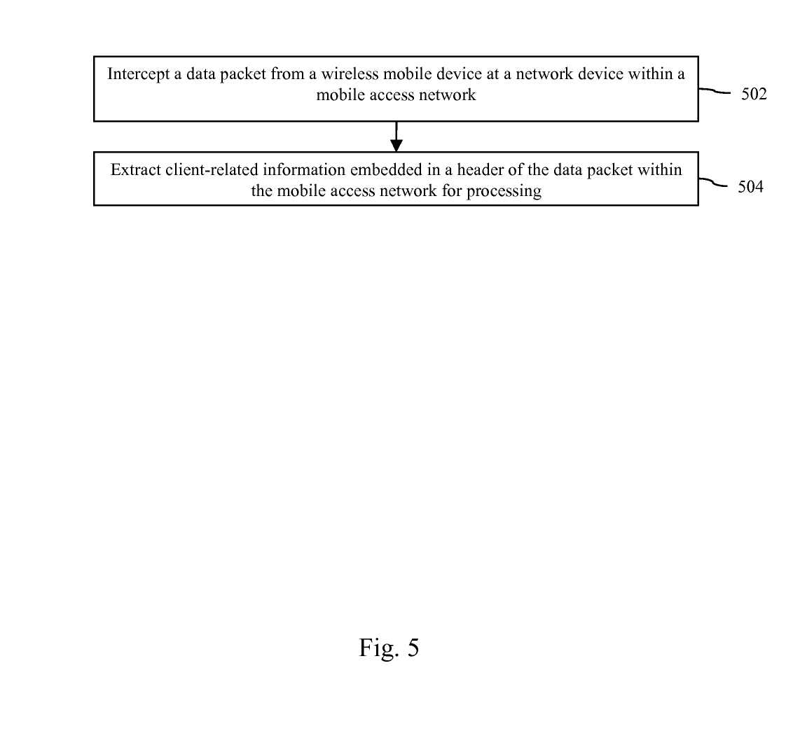

A method for tagging client/network information in headers of mobile data packet traffic in accordance with an embodiment of the invention is described with reference to FIG. 5. At block 502, a data packet from a wireless mobile device is intercepted at a network device within a mobile access network. The data packet includes client-related information embedded in a header of the data packet. The client-related information includes information about the wireless mobile device that sent the data packet or information residing in the wireless mobile device. At block 504, the client-related information embedded in the header of the data packet is extracted within the mobile access network for processing.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for tagging client/network information in mobile data packet traffic, the system comprising:
a packet interception unit configured to intercept a data packet from a wireless mobile device, the data packet including client-related information embedded in a header of the data packet, the client-related information including information about a wireless mobile device that sent the data packet or information residing in the wireless mobile device; and
at least one processing unit configured to receive the data packet from the packet interception unit, the at least one processing unit being further configured to extract the client-related information embedded in the header of the data packet for processing.

2. The system of claim 1 wherein the at least one processing unit is configured to extract the client-related information from an Internet Protocol (IP) options field of an IP header of the data packet.

3. The system of claim 1 wherein the at least one processing unit is configured to extract the client-related information from a Transmission Control Protocol (TCP) options field of a TCP header of the data packet.

4. The system of claim 1 wherein the client-related information includes an identification of an application running on the wireless mobile device from which the data packet originated.

5. The system of claim 1 wherein the client-related information includes a sensor data generated by a sensor of the wireless mobile device.

6. The system of claim 1 wherein the client-related information includes system status information of the wireless mobile device.

7. The system of claim 1 wherein the at least one processing unit includes an in-line processing unit configured to embed network-related information embedded in a header of a data packet to be transmitted to the wireless mobile device.

8. The system of claim 7 wherein the in-line processing unit is configured to embed the network-related information in an Internet Protocol (IP) options field of an IP header of the data packet or in a Transmission Control Protocol (TCP) options field of a TCP header of the data packet.

9. The system of claim 7 wherein the network-related information includes traffic conditions in a mobile access network.

10. A method for tagging client/network information in mobile data packet traffic, the method comprising:
intercepting a data packet from a wireless mobile device at a network device within a mobile access network, the data packet including client-related information embedded in a header of the data packet, the client-related information including information about the wireless mobile device that sent the data packet or information residing in the wireless mobile device; and
extracting the client-related information embedded in the header of the data packet within the mobile access network for processing.

11. The method of claim 10 wherein the extracting includes extracting the client-related information from an Internet Protocol (IP) options field of an IP header of the data packet.

12. The method of claim 10 wherein the extracting includes extracting the client-related information from a Transmission Control Protocol (TCP) options field of a TCP header of the data packet.

13. The method of claim 10 wherein the client-related information includes an identification of an application running on the wireless mobile device from which the data packet originated.

14. The method of claim 10 wherein the client-related information includes a sensor data generated by a sensor of the wireless mobile device.

15. The method of claim 10 wherein the client-related information includes system status information of the wireless mobile device.

16. The method of claim 10 further comprising embedding network-related information embedded in a header of a data packet to be transmitted to the wireless mobile device.

17. The method of claim 16 wherein the embedding includes embedding the network-related information in an Internet Protocol (IP) options field of an IP header of the data packet or in a Transmission Control Protocol (TCP) options field of a TCP header of the data packet.

18. The method of claim 16 wherein the network-related information includes traffic conditions in a mobile access network.

19. A method for tagging client/network information in mobile data packet traffic, the method comprising:
intercepting a data packet from a wireless mobile device at a network device within a mobile access network, the data packet including client-related information embedded in a header of the data packet, the client-related information including an identification of an application running on the wireless mobile device from which the data packet originated; and
extracting the client-related information embedded in the header of the data packet within the mobile access network for processing.

20. The method of claim 19 wherein the extracting includes extracting the client-related information from an Internet Protocol (IP) options field of an IP header of the data packet or from a Transmission Control Protocol (TCP) options field of a TCP header of the data packet.
